(19) United States
(12) Patent Application Publication
(10) Pub. No.: US 2015/0319678 A1
(43) Pub. Date: Nov. 5, 2015

(54) METHOD AND APPARATUS FOR ANTI-BLOCKING HETNET DEPLOYMENT

(71) Applicants: ZTE WISTRON TELECOM AB, Kista (SE); ZTE (TX) INC., Austin, TX (US)

(72) Inventors: Jan JOHANSSON, Kista (SE); Aijun CAO, Kista (SE); Patrick SVEDMAN, Kista (SE); Thorsten SCHIER, Kista (SE); Yonghong GAO, Kista (SE); Bojidar HADJISKI, Kista (SE)

(73) Assignee: ZTE WISTRON TELECOM AB, Kista (SE)

(21) Appl. No.: 14/651,615

(22) PCT Filed: Dec. 11, 2013
(86) PCT No.: PCT/US13/74481

§ 371 Date: Jun. 11, 2015

Related U.S. Application Data
(60) Provisional application No. 61/737,021, filed on Dec. 13, 2012.
(60) Provisional application No. 61/737,041, filed on Dec. 13, 2012.

(51) Int. Cl. H04W 48/16; H04L 1/00; H04W 36/04; H04W 74/00

(52) U.S. Cl. CPC H04W 48/16; H04W 74/002; H04L 1/0057; H04W 36/04; H04W 88/02

(57) ABSTRACT

A new approach to anti-blocking cellularcommunication for HetNet deployment is proposed. First, a block detector sends a block indicator from an LPN to a scheduler in a macro base station. The scheduler then collects the block indicator statistics of each LPN on a sub-frame basis and updates the statistics in each sub-frame. If the statistics of received block indicators for one sub-frame during an observation period of a specific LPN exceeds a first predefined threshold, then the scheduler will not schedule any more uplink transmission to the LPN during the sub-frame for those UEs which are connected to the LPN. When the statistics of received block indicators becomes less than a second predefined threshold, which is less than the first threshold, the scheduler removes the limitation on uplink transmission to the LPN and allocates the sub-frame of the LPN as usual.

### RELATED PATENT APPLICATIONS

This application claims benefit of priority under 35 U.S.C. §119(e) to Provisional Application No. 61/737,021, entitled “Anti-blocking Scheduler for HetNet Deployment,” filed Dec. 13, 2012, which is incorporated by reference herein in its entirety.

This application claims benefit of priority under 35 U.S.C. §119(e) to Provisional Application No. 61/737,041, entitled “Method and Apparatus for a Blocking Detector in a Digital Communication System,” filed Dec. 13, 2012, which is incorporated by reference herein in its entirety.

### FIELD OF THE INVENTION

The present invention relates generally to cellular telecommunication systems, such as heterogeneous networks where multiple low-power nodes are deployed within the coverage of a macro base station.

### BACKGROUND OF THE INVENTION

Cellular communication systems provides not only voice services, but also mobile broadband services all over the world. As more and more applications executable on cell phones are emerging, which consume higher and higher data, demands for mobile broadband data services have been increasing exponentially, requiring operators of the cellular communication systems to improve data throughput wherever and whenever possible.

As the spectrum efficiency for the point-to-point link approaching its theoretical limit, one way to improve data throughput of a cellular communication system is to split big cells into smaller and smaller cells. When cells becomes closer to each other, however, adjacent cell interferences become more severe, and the cell splitting gain saturates. Furthermore, it is becoming increasingly difficult and costly for the operators to acquire new sites to install base stations. Therefore, cell-splitting cannot fulfill the demands for mobile broadband data services.

Recently a new type of cellular communication system deployment, called Heterogeneous Network or HetNet in short, has been proposed, which is attracting a lot of interest and effort in the industry. In a HetNet, an additional tier including multiple low-power nodes (LPNs) is added into the cellular communication system within the coverage of an existing macro base station, wherein the macro base station monitors, controls, and schedules communications with the LPs in a master-slaves relationship in the HetNet in order to have better interference management and resource allocation, etc.

In one non-limiting example of a HetNet deployment where all LPNs are within the coverage of one macro base station, user equipment devices (UEs) such as mobile devices rely on the LPNs to establish their connections (e.g., uplinks) with the macro base station. Here, each LPN receives a sum of the wanted information-bearing waveform as well as other interfering signals and noise from its connecting UEs. Both the UEs and the LPNs are instructed to communicate with each other according to a scheduler situated at the macro base station, although each UE may not be aware of the location of the LPN it communicates with in the cellular communication system.

There is, however, one inherent problem with this mechanism. An LPN typically has a range of input signal powers that it can handle. If the input signal power is too low, the LPN cannot resolve the signal. If on the other hand, the input signal power is too high, the LPN cannot resolve the signal either due to corruption and distortion or other factors. In the case where one or more UEs happen to be close to one LPN and far away from the macro base station, the initial uplink transmission power, such as a random access signal (a random access preamble in the case of LTE) to connect to the network and/or the first transmitted uplink message, may be unnecessarily high in order to be heard by the macro base station. This unnecessary high transmit power generates uplink co-channel interferences which deteriorates the uplink capacity. In the worst case, this unnecessary high transmit power by the UEs could block the receiving chain at the LPN close to the UEs. If the uplink receiving chain of the LPN is blocked, all signals received at the LPN may be corrupted, even if their corresponding powers were on a suitable level. In addition, uplink data received by the LPN in the current sub-frame is saturated and the saturated data in the current sub-frame may further pollute the data buffer received in the previous uplink transmissions, which requires extra retransmission of the data in order to offset the pollution.

### SUMMARY OF THE INVENTION

One object of the invention is to actively avoid or decrease the above-described degradations and disadvantages. In one embodiment of the invention, a block detector sends a block indicator from an LPN to a scheduler in a macro base station. The scheduler collects the block indicator statistics from each LPN on a sub-frame basis, and updates the statistics in each sub-frame . If the statistics of received block indicators for one sub-frame during an observation period of a specific LPN exceeds a first predefined threshold, then the scheduler will not schedule any more uplink transmission to the LPN during the sub-frame for those UEs which are connected to the LPN. When the statistics of received block indicators becomes less than a second predefined threshold, which is less than the first threshold, the scheduler removes the limitation on uplink transmission to the LPN and allocates the sub-frame of the LPN as usual.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily made to scale.

FIG. 1 depicts an example of an anti-blocking cellular communication system 100 for HetNet deployment.

FIG. 2 depicts an example of the analog portion of an LPN to determine the indicator of a blocking situation.

FIG. 3 depicts an example of the digital portion of an LPN to determine the indicator of a blocking situation.

FIG. 4 depicts an example of a suitable range of a time period for detecting a blocking situation.

FIG. 5 shows one example of scheduler using statistics of block indicator to schedule the transmission of uplink communications from an LPE during an observation period that includes a plurality of sub-frames.

FIG. 6 depicts a flowchart of an example of a process to support anti-blocking cellular communication for HetNet deployment.

### DETAILED DESCRIPTION OF EXEMPLARY EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

In the following description of exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

The present invention is directed toward systems and methods for a cellular or mobile communication system. Embodiments of the invention are described herein in the context of one practical application, namely, communication between a base station and a plurality of UEs/mobile devices via a plurality of LPNs. In this context, the example system is applicable to provide data communications between the base station and the plurality of mobile devices through the LPNs. The invention, however, is not limited to such base station and mobile device communications applications, and the methods described herein may also be utilized in other applications such as mobile-to-mobile communications, wireless local loop communications, wireless relay communications, or wireless backhaul communications, for non-limiting examples.

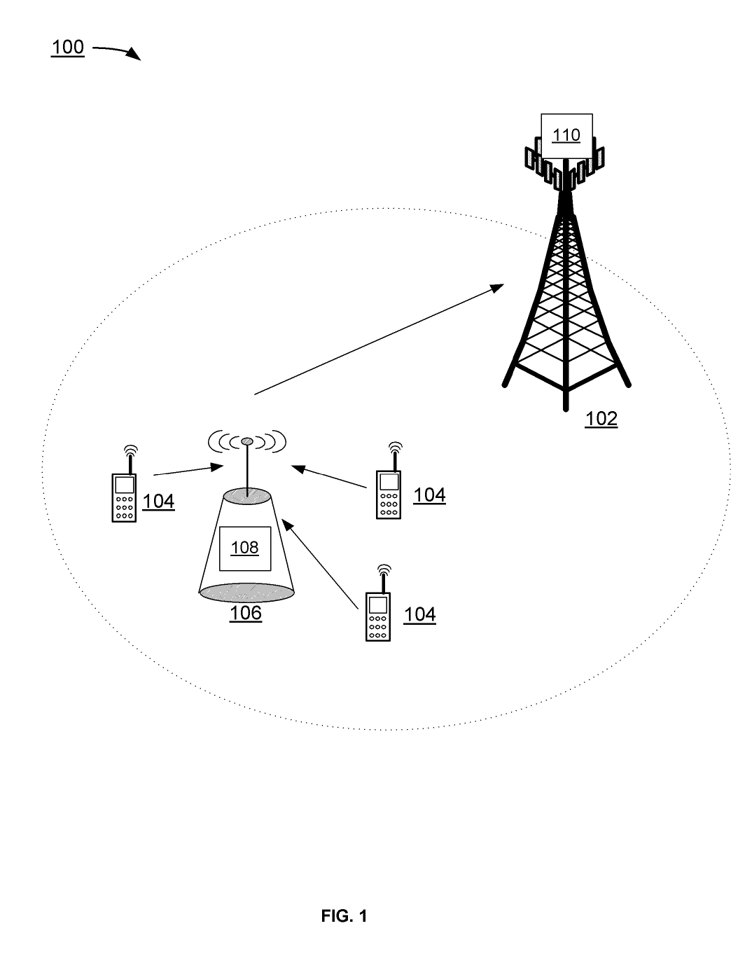

FIG. 1 depicts an example of an anti-blocking cellular communication system 100 for HetNet deployment. Although the diagrams depict components as functionally separate, such depiction is merely for illustrative purposes. It will be apparent that the components portrayed in this figure can be arbitrarily combined or divided into separate software, firmware and/or hardware components.

In the example of FIG. 1, system 100 includes at least one macro base station 102 each having a scheduler 110, one or more low-power nodes (LPNs) 106 within the coverage of macro base station 102 and all share the same cell identifier associated with the macro base station 102, wherein the one or more LPNs 106 each has one or more block detectors 108. A plurality of mobile or user equipment devices (UEs) 104 connect to one of the LPNs 106 for communication with macro base station 102, wherein each UE 104 can be but is not limited to one of a mobile computing, storage, or communication device, such as a laptop PC, a tablet PC, an iPod, an iPhone, an iPad, a Google's Android device, a portable storage device, and a cell phone. During operation, UEs 104 of the system 100 communicates with macro base station 102 through LPNs 106, wherein each UE 104 connects to one of the LPNs 106 within the coverage of macro base station 102 of the system 100. The LPN 106 receives the uplink communication data from the UEs 104 that connect to the LPN 106 and then communicates the uplink data received from the UEs 104 to the macro base station 102. In some embodiments, the LPN 106 is controlled by macro base station 102 in a master-slave configuration.

In the example of FIG. 1, the one or more block detector 108 in each LPN 106 detect whether the uplink communication received at the LPN 106 is blocked due to high-power transmission by nearby UEs 104 during a certain time period and provides blocking information detected to macro base station 102 in the form of block indicators. In some embodiment, block detector 108 analyzes the incoming waveform of uplink communications from its connecting UEs 104 to determine if a blocking condition at the LPN 106 has occurred. Since the blocking situation can occur either in the analog part or in the digital part of LPN 106, block detector 108 performs the analysis of the incoming waveform in either the analog RF waveform or in the digital form or both.

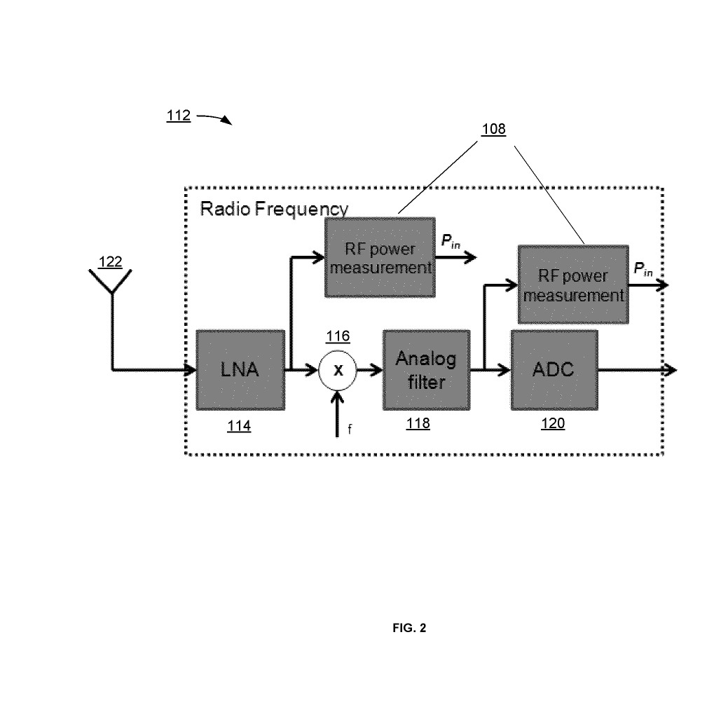

When analyzing the incoming waveform in the analog form, block detector 108 utilizes the power/amplitude of the incoming waveform as an indicator of the blocking situation. FIG. 2 depicts an example of the analog portion 112 of LPN 106 to determine the indicator of the blocking situation, which in addition to block detector 108, may further include one or more of: low noise amplifier (LNA) 114, multiplier 116, analog filter 118, and analog-to-digital converter (ADC) 120. During operation, LPN 106 receives the incoming waveform from the UEs 104 through its antenna 122 and amplifies the received incoming waveform via LNA 114. LPN 106 then converts the incoming waveform to an analog baseband waveform or an intermediate frequency waveform by multiplying the incoming waveform with another waveform that has the same carrier frequency fat multiplier 116 followed by a low pass analog filter 118 to suppress frequencies higher than the baseband waveform. LPN 106 then converts the analog waveform to a digital baseband waveform using ADC 120 before providing the waveform to digital portion of LPN 106 for further digital signal processing (DSP).

In some embodiments, block detector 108 in the analog portion 112 of LPN 106 measures the total power of the incoming waveform received at LPN 106 over a certain time period. If the measured power, Pin, is above a certain threshold (e.g., −45 dBm at the antenna 122), block detector 108 then regards a blocking situation has occurred at LPN 106 and generates a block indicator accordingly. As shown in FIG. 2, the measuring point of block detector 108 can be either after LNA 114 (after the received analog waveform has been amplified) or after analog filter 118 (after high frequencies in the waveform have been suppressed).

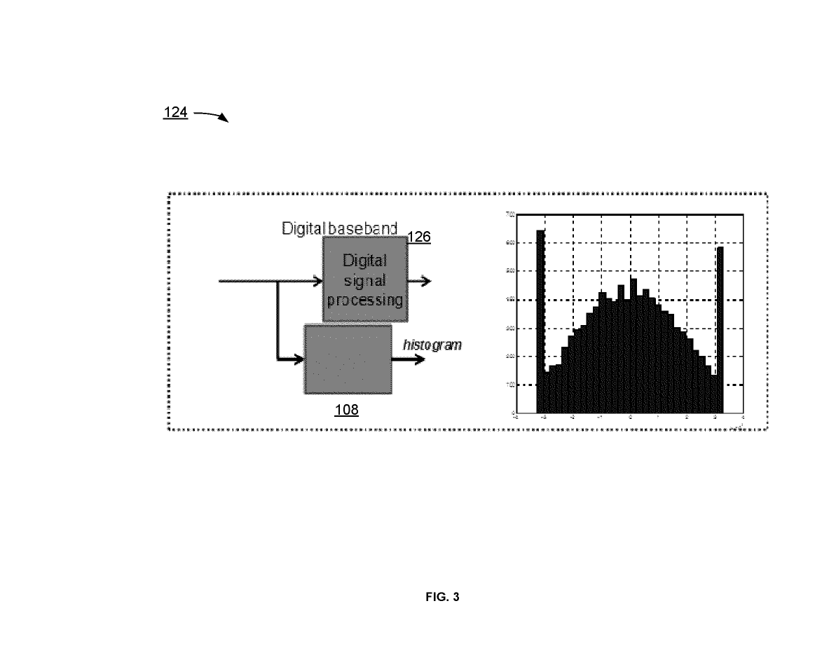

In some embodiments, after the incoming waveform has been converted by ADC 120 to a digital baseband waveform, block detector 108 analyzes the incoming waveform in the digital form by generating a histogram of samples of the waveform that belong to the certain time period as shown by the example of the digital portion 124 of LPN 106 depicted in FIG. 3 to determine the indicator of the blocking situation. Here, the digital waveform is represented by samples represented via a certain number of bits. The number of samples that have either the maximum positive value or the maximum negative values are counted. For a non-limiting example, if the digital waveform after conversion by ADC 120 is represented with N bits in 2-complement, then the maximum positive sample value is (2^{N-1}−1) and the maximum negative sample value is −2^{N-1}). If the number of maximum positive and negative value samples counted by block detector 108 is above a certain threshold, then block detector 108 determines that a blocking has occurred at LND 106. As shown in FIG. 3, block detector 108 may analyze the digital waveform before the digital waveform is provided to digital signal processor 126 for further processing in accordance with the wireless communication standard.

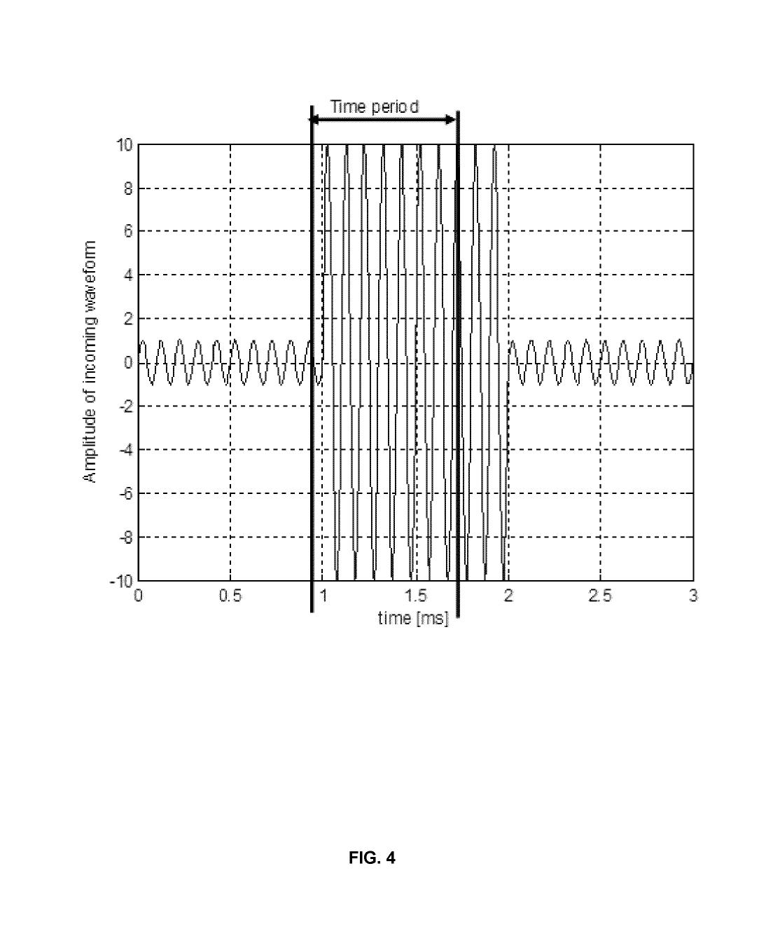

In some embodiments, the time period during which block detector 108 of LPN 106 detects blocking situation at the analog and/or the digital portion of LPN 106 depends on the communication standard that is used for the communication system 100 among macro base station 102, UEs 104, and LPNs 106. Specifically, the time period should be long enough to ensure measurement accuracy by the block detector 108. On the other hand, if the time period is too long, for example longer than the time the blocking situation at LPN 106 is present, it can result in missed detection of the blocking by the block detector 108 As such, various time periods can be used. For a non-limiting example, in the case of LTE, a suitable range for the time period is between 1/14^{th} ms to 1 ms as illustrated by the example shown in FIG. 4. As shown in the example of FIG. 4, the time period may advantageously be selected to correspond to the period when the blocking situation happens at LPN 106 for blocking detection by block detector 108 as indicated by the amplitude of the incoming waveform from the UEs 104.

In some embodiments, block detector 108 utilizes knowledge about the time and frequency allocation of uplink transmissions by the UEs 104 that are served by the LPN 106, to detect if a blocking situation has occurred at the LPN 106. For a non-limiting example, under a wireless communication standard such as LTE, each LPN 106 measures the block error rate (BLER) for each UE 104 the LPN 106 serves, wherein BLER is the ratio of the number of erroneous blocks to the total number of blocks received from the UE 104 at the LPN 106. Block detector 108 may utilize the BLER of the UEs 104 as a measurement of a potential blocking situation at the LPN 106. If the BLER for one or several UEs 104 served by the LPN 106 is over a certain threshold (e.g., 90%) during a certain time period (e.g., 30 ms), block detector 108 then determines that a blocking situation has occurred at the LPN 106 and generates a blocking indicator accordingly.

Once the block detector 108 identifies that a blocking situation has occurred at the LPN 106, it generates and provides a block indicator to scheduler 110 in macro base station 102. Here, scheduler 110 schedules and controls the transmission and retransmissions (in case of transmission failures) of uplink and downlink communications between the UEs 104 and the base station 102 through the LPN 106 that serves these UEs 104. Once the block indicators from the LPN 106 have been received, scheduler 110 may then utilize such information in handling of the retransmissions of the uplink communications that have been blocked at LPN 106.

As referred to hereinafter, the term “scheduler” includes a combination of one or more of hardware, software, firmware, or other component that is used to effectuate a purpose. For a non-limiting example, the software instructions are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors.

As referred to hereinafter, a frame provides the main structure that governs how quickly UE 104/LPN 106 can acquire synchronization within a specified frame boundaries and begin communications with a base station 102. A frame is primarily characterized by a length, a presence of a synchronization signal, which is typically a preamble at the beginning of the frame, and control information that pertains to the frame. A sub-frame is defined as a contiguous number of time units of radio frequency (RF) resources within a frame that has the same direction property—i.e., either downlink or uplink connection/communication. By this definition, a sub-frame is characterized by at least two parameters: 1) a direction (either downlink or uplink) and 2) a length or duration. In some embodiments, there may be two consecutive sub-frames that possess the same directionality (e.g. downlink sub-frame followed by another downlink sub-frame). In some embodiments, a sub-frame may include a plurality of unit sub-frames of identical or compatible configurations and the length/time duration of the sub-frame is determined by the number of unit sub-frames in the sub-frame, with the minimum length of the sub-frame being one unit sub-frame and the maximum length of the sub-frame being governed by the length of the frame partition in which the sub-frame belongs. The length of the sub-frame determines the change rate of link direction (downlink or uplink) and configuration of the sub-frame has a direct impact on transfer latency and therefore, on quality of service (QoS) and on signaling response latency.

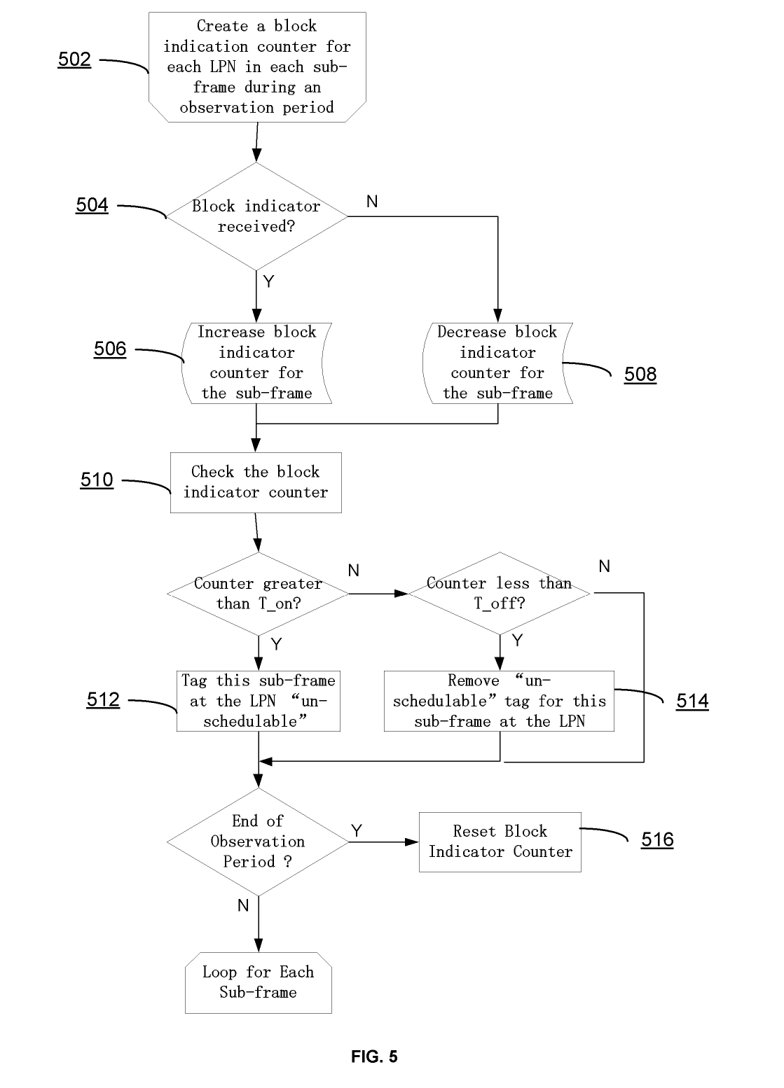

FIG. 5 shows one example of scheduler 110 using statistics of block indicator to schedule the transmission of uplink communications from an LPE during an observation period that includes a plurality of sub-frames. In the example of FIG. 5, a simple counter of number of block indicators received for each sub-frame within the observation period is used as a non-limiting example of the block indicator statistics variable. Other forms of the statistics variables can also be used following a similar working flow.

As shown in FIG. 5, scheduler 110 creates a block indicator counter within a context of each LPN 106 controlled by the scheduler 110 for each sub-frame during an observation period at base station 102 at block 502. If scheduler 110 receives a block indicator from block detector 108 at the LPN 106 under control for the sub-frame at block 504, scheduler 110 increases the block indicator counter of the LPN 106 for the sub-frame at block 506. If, on the other hand, a block indicator from LPN 106 is not received by the scheduler 110 for the sub-frame, scheduler 110 decreases the block indicator counter of the LPN 106 for the sub-frame at block 508. Scheduler 110 then checks the block indicator counter of LPN 106 for the sub-frame at block 510. If the block indicator counter hits a predefined threshold Ton, which indicates that the LPN 106 is likely being blocked, scheduler 110 then tags the sub-frame as “un-schedulable” for the concerned LPN 106 at block 512, meaning that scheduler 110 will not allocate uplink resources to the UEs 104 whose uplink communications are received by the concerned LPN 106. If the block indicator counter of the LPN 106 for the sub-frame does not hit the predefined threshold T_on and is less than another predetermined threshold T_off, which is less than T_on and indicates that the LPN 106 is likely unblocked, scheduler 110 then removes the previously set “unsechedulable” tag for the sub-frame at the concerned LPN 106 at block 514, meaning that scheduler 110 will resume to allocate uplink resources to the UEs 104 whose uplink communications are received by the concerned LPN 106. The scheduler 110 repeats block 502 through block 514 for each sub-frame until the end of the observation period is reached. At that time, the scheduler 110 resets the block indicator counter for the LPN 106 at block 516.

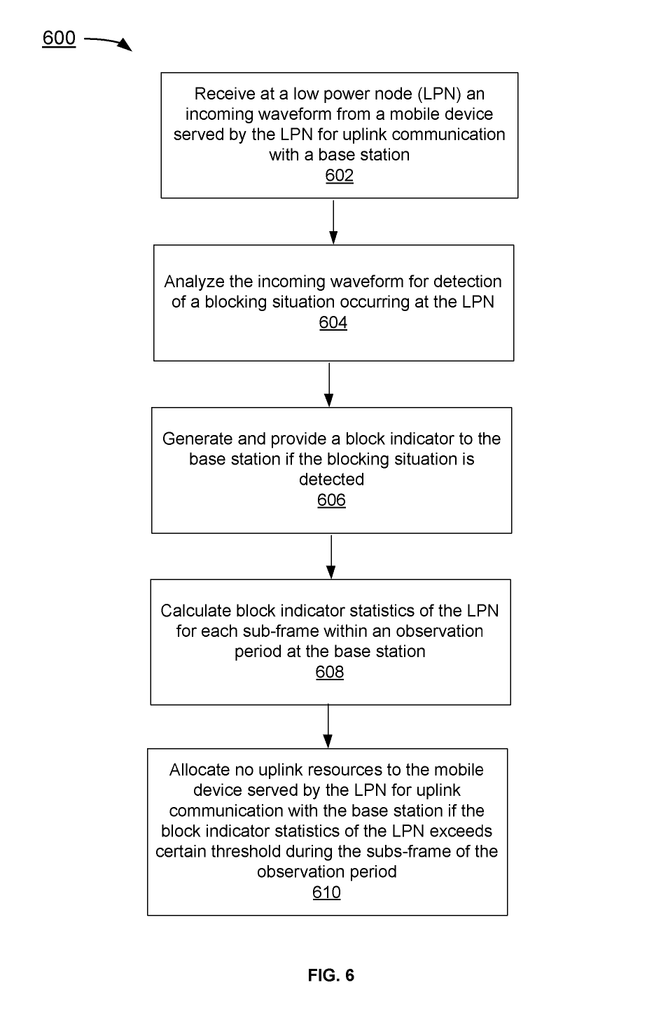

FIG. 6 depicts a flowchart 600 of an example of a process to support anti-blocking cellular communication for HetNet deployment. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 6, the flowchart 600 starts at block 602, where an incoming waveform from a mobile device is received at a low power node (LPN) for uplink communication with a base station. The flowchart 600 continues to block 604, where the incoming waveform is analyzed for detection of a blocking situation occurring at the LPN. The flowchart 600 continues to block 606, where a block indicator is generated and provided to the base station if the blocking situation is detected. The flowchart 600 continues to block 608, where block indicator statistics of the LPN is calculated for each sub-frame within an observation period at the base station. The flowchart 600 ends at block 610, where no uplink resources are allocated to the mobile device served by the LPN for uplink communication with the base station if the block indicator statistics of the LPN exceeds certain threshold during the subs-frame of the observation period.

While various embodiments of the invention have been described above, it should be understood that they have been presented by way of example only, and not of limitation. Likewise, the various diagrams may depict an example architectural or other configuration for the invention, which is done to aid in understanding the features and functionality that can be included in the invention. The present invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

One or more of the functions described in this document may be performed by an appropriately configured module. The term “module” as used herein, refers to software that is executed by one or more processors, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

Additionally, one or more of the functions described in this document may be performed by means of computer program code that is stored in a “computer program product”, “computer-readable medium”, and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

What is claimed is:

1. A system to support anti-blocking cellular communication for heterogeneous network (HetNet) deployment, comprising:
a scheduler in a base station, which in operation,
accepts at the base station a block indicator from a low power node (LPN) within a coverage of the base station, wherein the block indicator indicates that a blocking situation at the LPN has been detected;
calculates block indicator statistics of the LPN for each sub-frame within an observation period at the base station;
allocates no uplink resources to a mobile device served by the LPN for uplink communication with the base station if the block indicator statistics of the LPN exceeds a first threshold during the subs-frame of the observation period.

2. The system of claim 1, wherein:
the scheduler controls and schedules transmission and retransmission of the uplink communication between the mobile device and the base station through the LPN.

3. The system of claim 2, wherein:
the scheduler utilizes the block indicator statistics in handling of the retransmission of the uplink communication that has been blocked at the LPN.

4. The system of claim 1, wherein:
the sub-frame is a contiguous number of time units of radio frequency (RF) resources within a frame that has the same direction property for uplink or downlink communication.

5. The system of claim 1, wherein:
the block indicator statistics is a counter of block indicators received for each sub-frame within the observation period.

6. The system of claim 1, wherein:
the scheduler updates the block indicator statistics based on the block indictors received for the sub-frame during the observation period.

7. The system of claim 1, wherein:
the scheduler tags the sub-frame as “un-schedulable” for the LPN if the block indicator statistics of the LPN exceeds the first threshold during the subs-frame of the observation period.

8. The system of claim 7, wherein:
the scheduler removes the “un-schedulable” tag on the sub-frame for the LPN if the block indicator statistics of the LPN becomes less than a second threshold that is less than the first threshold during the subs-frame of the observation period.

9. The system of claim 1, wherein:
the scheduler resumes to allocate uplink resources to the mobile device whose uplink communication is received by the LPN if the block indicator statistics of the LPN becomes less than a second threshold that is less than the first threshold during the subs-frame of the observation period.

10. The system of claim 1, further comprising:
a block detector in the LPN, which in operation,
receives at the LPN an incoming waveform from the mobile device served by the LPN for uplink communication with the base station;
analyzes the incoming waveform to detect the blocking situation occurring at the LPN during a time period;
generates and provides the block indicator to the base station if the blocking situation is detected.

11. The system of claim 10, wherein:
the block detector detects whether the uplink communication received at the LPN is blocked due to high-power transmission by one or more nearby user equipment devices during the time period.

12. The system of claim 10, wherein:
the block detector analyzes the incoming waveform in analog form.

13. The system of claim 10, wherein:
the block detector analyzes the incoming waveform after the waveform is converted to a digital form.

14. The system of claim 10, wherein:
the block detector utilizes knowledge about time and frequency allocation of the uplink transmissions by the mobile device served by the LPN to detect the blocking situation.

15. A method to support anti-blocking cellular communication for heterogeneous network (HetNet) deployment, comprising:
accepting at a base station a block indicator from a low power node (LPN) within a coverage of the base station, wherein the block indicator indicates that a blocking situation at the LPN has been detected;
calculating block indicator statistics of the LPN for each sub-frame within an observation period at the base station;
allocating no uplink resources to a mobile device served by the LPN for uplink communication with the base station if the block indicator statistics of the LPN exceeds certain threshold during the subs-frame of the observation period.

16. The method of claim 15, further comprising:
controlling and scheduling transmission and retransmission of the uplink communication between the mobile device and the base station through the LPN.

17. The method of claim 15, further comprising:
utilizing the block indicator statistics in handling of the retransmission of the uplink communication that has been blocked at the LPN.

18. The method of claim 15, further comprising:
updating the block indicator statistics based on the block indictors received for the sub-frame during the observation period.

19. The method of claim 15, further comprising:
tagging the sub-frame as “un-schedulable” for the LPN if the block indicator statistics of the LPN exceeds the first threshold during the subs-frame of the observation period.

20. The method of claim 19, further comprising:
removing the “un-schedulable” tag on the sub-frame for the LPN if the block indicator statistics of the LPN becomes less than a second threshold that is less than the first threshold during the subs-frame of the observation period.

21. The method of claim 19, further comprising:
resuming to allocate uplink resources to the mobile device whose uplink communication is received by the LPN if the block indicator statistics of the LPN becomes less than a second threshold that is less than the first threshold during the subs-frame of the observation period.

22. The method of claim 15, further comprising:
receiving at the LPN an incoming waveform from the mobile device served by the LPN for uplink communication with the base station;
analyzing the incoming waveform to detect the blocking situation occurring at the LPN during a time period;
generating and providing the block indicator to the base station if the blocking situation is detected.

23. The method of claim 22, further comprising:
detecting whether the uplink communication received at the LPN is blocked due to high-power transmission by one or more nearby user equipment devices during the time period.

24. The method of claim 22, further comprising:
analyzing the incoming waveform in analog form.

25. The method of claim 22, further comprising:
analyzing the incoming waveform after the waveform is converted to a digital form.

26. The method of claim 22, further comprising:
utilizing knowledge about time and frequency allocation of the uplink transmissions by the mobile device served by the LPN to detect the blocking situation.
